(19) United States
(12) Patent Application Publication
(10) Pub. No.: US 2015/0138138 A1
(43) Pub. Date: May 21, 2015

(54) TOUCH PANEL AND FORMATION OF ELECTRODE

(71) Applicant: LG INNOTEK CO., LTD., Seoul (KR)

(72) Inventors: Ji Hyouk Chung, Seoul (KR); Jong Woon Moon, Seoul (KR)

(21) Appl. No.: 14/401,891

(22) PCT Filed: Apr. 4, 2013
(86) PCT No.: PCT/KR2013/002813

§ 371 Date: Nov. 18, 2014

(30) Foreign Application Priority Data
May 18, 2012 (KR) 10-2012-0053324

(51) Int. Cl. G06F 1/16; G06F 3/045; G06F 3/044

(52) U.S. Cl. CPC G06F 1/16; G06F 3/044; G06F 3/045
USPC 345/174

(57) ABSTRACT

Disclosed are a touch panel and a method of forming an electrode. The touch panel includes a substrate on which a reference direction is defined; and an electrode on the substrate, the electrode including nano-wires, wherein the nano-wires are oriented in the reference direction. The method of forming an electrode includes forming a nano-wire on a substrate on which a reference direction is defined; and orienting the nano-wire in the reference direction.

### TECHNICAL FIELD

The disclosure relates to a touch panel and a formation of an electrode.

### BACKGROUND ART

Recently, a touch panel, which performs an input function through the touch of an image displayed on a display device by an input device such as a stylus pen or a hand, has been applied to various electronic appliances.

The touch panel may be mainly classified into a resistive touch panel and a capacitive touch panel. In the resistive touch panel, glass is shorted with an electrode due to the pressure of the input device so that a touch point is detected. In the capacitive touch panel, the variation in capacitance between electrodes is detected when a finger of the user is touched on the capacitive touch panel, so that the touch point is detected.

A nano-wire, which is a material substituting for ITO (Indium Tin Oxide), has been proposed as an electrode of the touch panel. The nano-wire is superior to the ITO in various characteristics such as transmittance or conductivity.

The nano-wires have a characteristic of scattering the incident light so that the electrode including the nano-wire is seen dimly. For this reason, the visibility of the touch panel is deteriorated. Thus, it is important to relieve the dim phenomenon by reducing the nanowires which do not contribute to the conductivity.

### DISCLOSURE

### Technical Problem

The embodiment provides a touch panel having improved reliability.

### Technical Solution

According to the embodiment, there is provided a touch panel including a substrate on which a reference direction is defined; and an electrode on the substrate, the electrode including nano-wires, wherein the nano-wires are oriented in the reference direction.

Further, there is provided a method of forming an electrode according to the embodiment. The method includes forming a nano-wire on a substrate on which a reference direction is defined; and orienting the nano-wire in the reference direction.

### Advantageous Effects

According to the embodiment, the nano-wires are oriented in the reference direction. As the nano-wires satisfy the degree of orientation, the electrode may have sufficient conductivity and low resistance even with a small amount of nano-wires. Further, since the number of nano-wires which do not contribute to conductivity is minimized, a total projection area of the nanowires scattering the incident light may be reduced. Thus, the dim phenomenon of the electrode caused by the nano-wires scattering the incident light can be reduced. Therefore, visibility and reliability of the electrodes including the nano-wires can be improved.

### DESCRIPTION OF DRAWINGS

FIG. 1 is a schematic plan view illustrating a touch panel according to the embodiment.

FIG. 2 is a sectional view taken along line II-II′ of FIG. 1.

FIG. 3 is an enlarged plan view of portion A of FIG. 1.

FIG. 4 is a view illustrating a degree of orientation of a nano-wire.

FIGS. 5 to 7 are views illustrating a method of forming an electrode according to the embodiment.

### BEST MODE

### Mode for Invention

In the following description of the embodiments, it will be understood that, when a layer (or film), a region, a pattern, or a structure is referred to as being “on” or “under” another substrate, another layer (or film), another region, another pad, or another pattern, it can be “directly” or “indirectly” on the other substrate, layer (or film), region, pad, or pattern, or one or more intervening layers may also be present. Such a position of the layer has been described with reference to the drawings.

The thickness and size of each layer shown in the drawings may be exaggerated, omitted or schematically drawn for the purpose of convenience or clarity. In addition, the size of elements does not utterly reflect an actual size.

Hereinafter, the embodiments will be described with reference to the accompanying drawings.

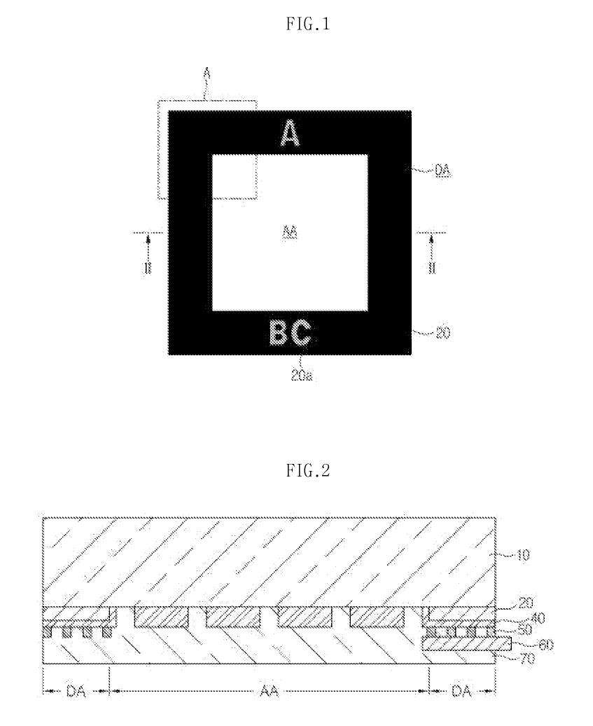

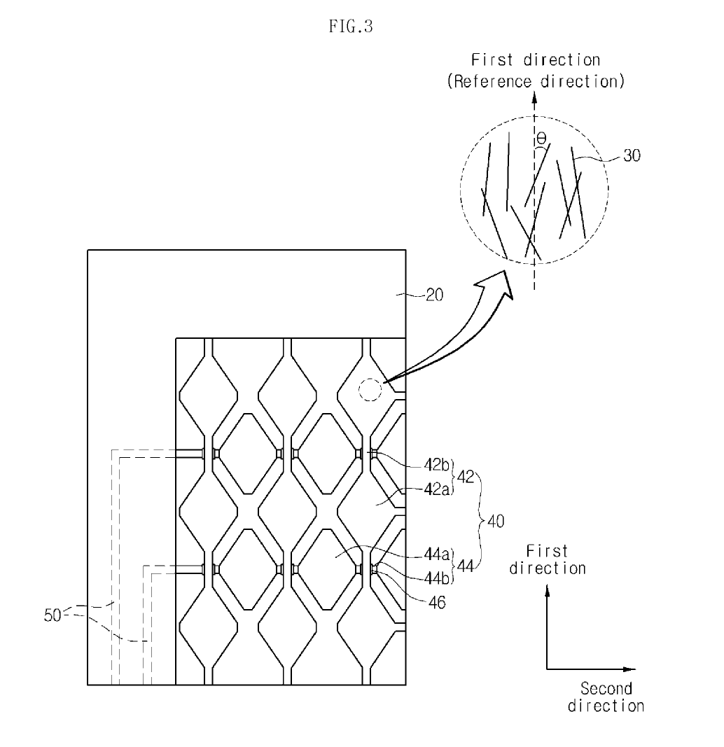

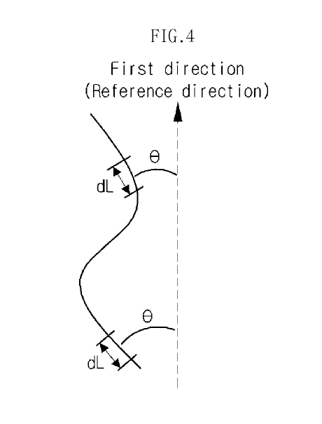

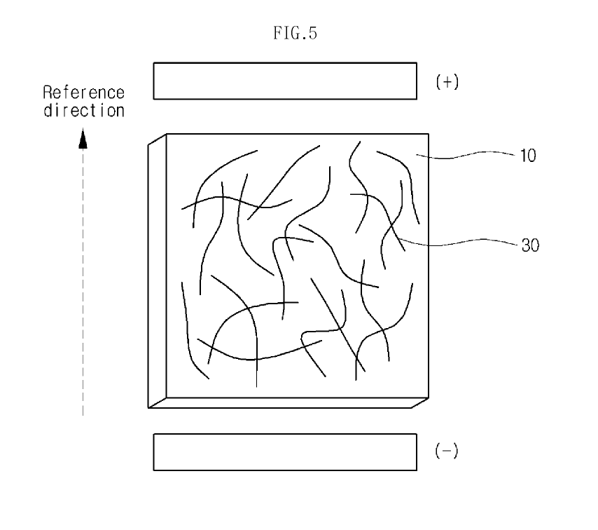

A touch panel according to the embodiment will be described in detail with reference to FIGS. 1 to 4. FIG. 1 is a plan view schematically showing the touch panel according to the embodiment. FIG. 2 is a sectional view taken along line II-II′ of FIG. 1. FIG. 3 is an enlarged plan view of portion A of FIG. 1. FIG. 4 is a view illustrating a degree of orientation of a nano-wire.

Referring to FIGS. 1 and 2, the touch panel according to the embodiment is defined by an effective area AA, in which the position of an input device is sensed, and a dummy area DA provided at an outer portion of the effective area AA.

In this case, the effective area AA may be provided therein with a transparent electrode 40 to sense an input device. In addition, the dummy area DA may be provided therein with a wire 50 connected to the transparent electrode 40 and a printed circuit board (not shown) to connect the wire 50 to an external circuit (not shown). The dummy area DA may be provided therein with an outer dummy layer 20. A logo 20a may be formed in the outer dummy layer 20. In addition, a planar layer 60 may be formed while covering the outer dummy layer 20. Hereinafter, the touch panel 100 will be described in more detail.

Referring to FIG. 2, the outer dummy layer 20, the transparent electrode 40 and the protective layer 70 may be formed on a substrate 10. The wire 50 may be connected to the transparent electrode 40. In addition, the wire 50 may be connected to the printed circuit board 60.

The substrate 10 may be formed of various materials to support the outer dummy layer 20, the transparent electrode 40 and the wire 50 which are formed thereon. For example, the substrate 10 may include a glass substrate or a plastic substrate.

The outer dummy layer 20 is formed in the dummy area DA on a first surface 12. The dummy layer 20 may be coated with a material having a predetermined color such that the wire 50 and the printed circuit board 60 are not seen from an outside. The outer dummy layer 20 may have a color suitable to a desired exterior thereof. As one example, the outer dummy layer 20 may have a black color by using a black pigment. A desired logo (reference numeral 20a in FIG. 1) may be formed on the outer dummy layer 20 by using various schemes. The outer dummy layer 20 may be formed through a deposition, print, or wet coating scheme.

The transparent electrode 40 is formed on the first surface 12. The transparent electrode 40 may formed in various shapes to sense whether an input device such as a finger is touched thereto. The transparent electrode 40 may be formed on the outer dummy layer 20 at a portion that the outer dummy layer 20 is formed.

As one example, as shown in FIG. 3, the transparent electrode 40 may include a first electrode 42 and a second electrode 44. The first and second electrodes 42 and 44 include sensing portions 42a and 44a for sensing whether an input device such as a finger is touched thereto, and connecting portions 42b and 44b for connecting the sensing portions 42a and 44a. The connecting portion 42b of the first electrode 42 connects the sensing portion 42a in a first direction (up and down directions in the drawing), and the connecting portion 44b of the second electrode 44 connects the sensing portion 44a in a second direction (left and right directions in the drawing).

An insulating layer 46 is placed between the connecting portions 42b and 44b of the first and second electrodes 42 and 44 at a portion at which the connecting portions 42b and 44b cross each other, so that the first and second electrodes 42 and 44 may be prevented from being electrically short-circuited between them. The insulating layer 46 may be formed of a transparent insulating material such that the connecting portions 42 and 44b may be insulated from each other. For example, the insulating layer 46 may include a metallic oxide such as a silicon oxide and resin such as acrylic.

As one example, according to the embodiment, the sensing portions 42a and 44a of the first and second electrodes 42 and 44 may be formed on the same layer, so that the sensing portions 42a and 44a may be formed as a single layer. Thus, usage of the transparent conductive material layer may be minimized and a thickness of the touch panel 100 may be reduced.

If the input device such as a finger is touched on the touch panel 100, the difference in capacitance is made in a portion touched by the input device, and the touched portion having the difference in capacitance may be detected as a touch point. Although a structure, in which the transparent electrode 40 is applied to a capacitive touch panel, is disclosed in the embodiment, the embodiment is not limited thereto. Thus, a structure, in which the transparent electrode 40 is applied to a resistive touch panel, may be formed.

The transparent electrode 40 may include a transparent conductive material allowing electricity to flow therethrough without interrupting the transmission of light. Specifically, the transparent electrode 40 may include a nano-wire 30. In detail, the transparent electrode 40 may include silver (Ag) nano-wire 30.

Meanwhile, the first direction and the second direction, which cross each other, are defined in the substrate 10. As described above, the first electrode 42 extends in the first direction. There is no need to allow the first electrode 42 to extend in the first direction. The angle between the first electrode 42 and the first direction may be in the range of 1° to 10°.

If it is defined that the first direction is a reference direction, the nanowires included in the first electrode 42 may be oriented in the reference direction. However, since all of the nano-wires 30 are not oriented, a degree of orientation will be defined for the purpose of describing the embodiment below.

Referring to FIG. 3, it may be defined that the nanowires 30 included in the first electrode 42 are aligned in one direction and θ is an angle between the one direction of the nanowires 30 and the reference direction. In this case, the degree of orientation is defined as following Equation 1:

cos θ≧0.7 Equation 1

According to the embodiment, the nano-wires 30 satisfying the degree of orientation may be 50% or more. In detail, the nano-wires 30 satisfying the degree of orientation may be in the range of 50% to 90%. Preferably, the nano-wires 30 satisfying the degree of orientation may be in the range of 70% to 99%.

The degree of orientation is an equation derived when it is assumed that the nano-wires 30 have a shape of a straight line. However, the nanowires 30 may substantially have shapes of not only a straight line but also a curved line. When the nano wires 30 have a shape of a curved line, the degree of orientation may be defined as follows.

Referring to FIG. 4, a vector W, which allows cos θ to have the maximum value in the following Equation 2, is set under the condition that L is an entire length of the nano-wire 30 having a shape of a curved line and θ is an angel between a differential length dL of the nano-wire 30 and a specific vector (in the reference direction of FIG. 4). The vector W indicates the representative directionality of the nano-wire 30 having the curved line. The cos θ defined by the vector W and the electrical connecting direction may be again calculated according to Equation 2.

$${〈 cos θ 〉}_{L} = \frac{{\int }_{L = 0}^{{L}_{wire}} cos θ d L}{{L}_{wire}} \qquad Equation 2$$

The cos θ may satisfy cos θ≧0.7 of Equation 1.

Meanwhile, the representative degree of orientation, which is representative of the directions of the nanowires 30, may be defined through Equation 2. This definition may be consistently used for a nano-wire 30 having an arbitrary shape as well as the shape of a straight line.

Meanwhile, when a sheet resistance of an electrode per a unit length of the nano-wire 30 in the first direction is defined as a first resistance and a sheet resistance of the electrode per a unit length of the nano-wire 30 in the second direction is defined as a second resistance in the first electrode, the second resistance is greater than the first resistance. The reason is that a magnitude of resistance according to an orientation direction is not constant as the nano-wires 30 included in the first electrode 42 are aligned according to the degree of orientation.

In detail, the ratio of the first resistance to the second resistance may be in the range of 1:1.1 to 1:10.

As the nano-wires 30 satisfy the degree of orientation, the nano-wires 30 are oriented in the reference direction. As the nano-wires satisfy the degree of orientation, the electrode may have sufficient conductivity and low resistance even with a small amount of nano-wires 30. Further, since the number of nano-wires 30 which do not contribute to conductivity is minimized, a total projection area of the nanowires 30 scattering the incident light may be reduced. Thus, the dim phenomenon of the electrode caused by the nano-wires 30 scattering the incident light can be reduced. Therefore, visibility and reliability of the electrodes including the nano-wires 30 can be improved

The transparent electrode 40 may be coated on the substrate 10 through various schemes. For example, the transparent electrode 40 may be coated on the substrate 10 through a dip coating scheme. The dip coating is one coating scheme in which a substrate is immersed in a coating solution or slurry to form a precursor layer on a surface of the substrate and then, the substrate is fired at a proper temperature to obtain a coating film.

However, the embodiment is not limited to the above. The transparent electrode 40 may be formed on the substrate 10 through various coating schemes such as spin coating, flow coating, spray coating, slot die coating or roll coating.

Referring to FIG. 2 again, the dummy area DA of the substrate 10 is provided therein with the wire 50 connected to the transparent electrode 40 and the printed circuit board 60 connected to the wire 40. Since the wire 50 is provided in the dummy area DA, the wire 50 may include metal representing superior electrical conductivity. The printed circuit board 60 may have various forms. For example, the printed circuit board may include a flexible printed circuit board (FPCB).

The protective layer 70 may be further placed while covering the transparent electrode 40.

Hereinafter, a method of forming an electrode according to the embodiment will be described with reference to FIGS. 5 to 7. FIGS. 5 to 7 are views illustrating the method of forming an electrode according to the embodiment.

According to the method of forming an electrode of the embodiment, the nanowires 30 may be formed on the substrate 10 in which the reference direction is defined and then, be oriented in the reference direction. In detail, current may be provided on the substrate 10 in the reference direction so that the nanowires 30 may be aligned in the direction corresponding to the reference direction. That is, the nano-wires 30 may be aligned in parallel to the reference direction.

First, referring to FIG. 5, in the orienting step, an electric field may be applied to one end and the other end of the nano-wire 30. That is, a positive (+) electrode and a negative (−) electrode are located at both ends of the nano-wire 30 to generate the electric field, such that the nano-wire 30 may be oriented.

Meanwhile, in the orienting step, the nano-wire 30 may be oriented in a mechanical scheme. As one example, in the orienting step, the nano-wire 30 may be rubbed. That is, the nano-wire 30 makes contact with an orientation member such that the nano-wire 30 may be oriented. The nano-wire 30 is rubbed with the orientation member, so that the nano-wire 30 may be oriented in the reference direction.

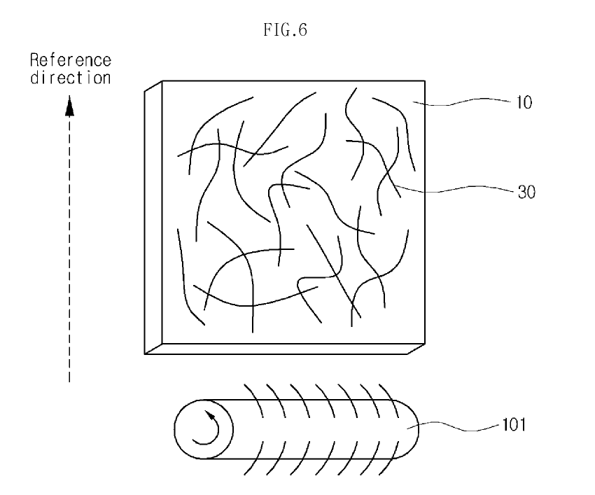

For example, referring to FIG. 6, the nano-wire 30 is allowed to make contract with a roller 101, such that the nano-wire 30 may be oriented. While the roller 101 is moving, the roller 101 is rubbed on the nano-wire 30 so that the nano-wire 30 may be oriented.

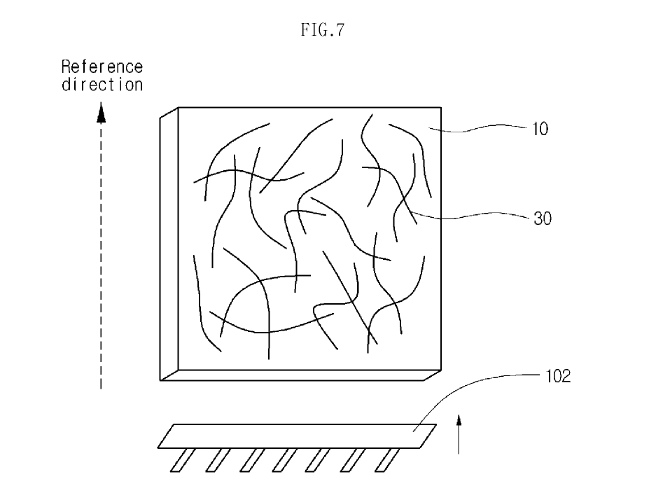

Referring to FIG. 7, the nano-wire 30 may be oriented by allowing a comb 102 to make contact with the nano-wire 30. As the comb 102 moves in the reference direction, the nano-wire 30 may be oriented.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effects such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A touch panel comprising:
a substrate on which a reference direction is defined; and
an electrode on the substrate, the electrode including nano-wires,
wherein the nano-wires are oriented in the reference direction.

2. The touch panel of claim 1, wherein the nano-wires are disposed in one direction, and the nano-wires satisfy following Equation 1,
cos θ≧0.7 Equation 1
wherein θ denotes an angle between the one direction and the reference direction.

3. The touch panel of claim 1, wherein, when θ denotes an angle between a differential length of the nano-wires and the reference direction, cos θ is defined as following Equation 2,
$${〈 cos θ 〉}_{L} = \frac{{\int }_{L = 0}^{{L}_{wire}} cos θ d L}{{L}_{wire}} \qquad Equation 2$$
wherein L denotes an entire length of a nano-wire and dL denotes the differential length.

4. (canceled)

5. The touch panel of claim 1, wherein the reference direction corresponds to an extension direction of the electrode.

6. The touch panel of claim 1, wherein an angle between the reference direction and the electrode is in a range of 0° to 10°.

7. The touch panel of claim 1, wherein the nano-wires include a silver (Ag) nano-wire.

8. A touch panel comprising:
a substrate on which a first direction and a second direction crossing the first direction are defined; and
an electrode extending in the first direction and including nano-wires,
wherein, when a sheet resistance of the electrode per a unit length of the nano-wire in the first direction is a first resistance and a sheet resistance of the electrode per a unit length of the nano-wire in the second direction is a second resistance, the second resistance is greater than the first resistance.

9. The touch panel of claim 8, wherein a ratio of the first resistance to the second resistance is in a range of 1:1.1 to 1:10.

10. The touch panel of claim 8, wherein the nano-wires are oriented in the first direction.

11.-19. (canceled)

20. The touch panel of claim 2, wherein the nano-wires have a shape of a straight line.

21. The touch panel of claim 20, wherein the nano-wires satisfying the Equation 1 are 50% or more.

22. The touch panel of claim 20, wherein the nano-wires satisfying the Equation 1 are in a range of 50% to 99%.

23. The touch panel of claim 20, wherein the nano-wires satisfying the Equation 1 are in a range of 70% to 99%.

24. The touch panel of claim 3, the cos θ satisfying the following Equation 1,
cos θ≧0.7 Equation 1

25. The touch panel of claim 2, wherein the nano-wires have a shape of a curved line.

26. The touch panel of claim 8, wherein the electrode includes a first electrode and a second electrode,
wherein the first and second electrodes are formed on the same layer.
